(19) United States
(12) Patent Application Publication
(10) Pub. No.: US 2025/0181928 A1
(43) Pub. Date: Jun. 5, 2025

(54) RAW TRAINING DATA-FREE MODEL FUSION

(71) Applicant: International Business Machines Corporation, Armonk, NY (US)

(72) Inventors: Luyao Shi, New Haven, CT (US); EHSAN DEGAN, Rancho Santa Margarita, CA (US); Prashanth Vijayaraghavan, Fremont, CA (US)

(21) Appl. No.: 18/527,248

(22) Filed: Dec. 2, 2023

(51) Int. Cl. G06N 3/096; G06N 3/045

(52) U.S. Cl. CPC G06N 3/096; G06N 3/045

(57) ABSTRACT

Generator neural networks are trained to produce synthetic samples that mimic training data used to train pretrained neural network models, respectively. Teaching assistant neural networks that learn from the pretrained neural network models are trained through knowledge distillation using samples produced by the generator neural networks. A student neural network that learns from the pretrained neural network models is trained through knowledge distillation using the synthetic samples produced by the trained generator neural networks.

### BACKGROUND

The present invention relates generally to the electrical, electronic and computer arts and, more particularly, to machine learning.

### BRIEF SUMMARY

Principles of the invention provide techniques for data-free model fusion. In one aspect, an exemplary method includes the operations of training generator neural networks to produce synthetic samples that mimic training data used to train pretrained neural network models, respectively; training teaching assistant neural networks that learn from the pretrained neural network models through knowledge distillation using samples produced by the generator neural networks; and training a student neural network that learns from the pretrained neural network models through knowledge distillation using the synthetic samples produced by the trained generator neural networks.

In one aspect, a computer program product comprises one or more tangible computer-readable storage media and program instructions stored on at least one of the one or more tangible computer-readable storage media, the program instructions executable by a processor, the program instructions comprising training generator neural networks to produce synthetic samples that mimic training data used to train pretrained neural network models, respectively; training teaching assistant neural networks that learn from the pretrained neural network models through knowledge distillation using samples produced by the generator neural networks; and training a student neural network that learns from the pretrained neural network models through knowledge distillation using the synthetic samples produced by the trained generator neural networks.

In one aspect, an apparatus comprises a memory and at least one processor, coupled to the memory, and operative to perform operations comprising training generator neural networks to produce synthetic samples that mimic training data used to train pretrained neural network models, respectively; training teaching assistant neural networks that learn from the pretrained neural network models through knowledge distillation using samples produced by the generator neural networks; and training a student neural network that learns from the pretrained neural network models through knowledge distillation using the synthetic samples produced by the trained generator neural networks.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
improvements to the technological process of machine learning by using knowledge distillation to combine pretrained models into one model for superior performance in terms of model performance (such as classification, robustness, and scalability), infrastructure usage (such as time, memory, and number of graphical processing units (GPUs)) and the like without the need for the raw training data of the pretrained models.
improvements to the technological process of machine learning by using knowledge distillation to combine pretrained models into one model for superior performance in terms of model performance (such as classification, robustness, and scalability), infrastructure usage (such as time, memory, and number of graphical processing units (GPUs)) and the like without the need for any real data (i.e., one or more embodiments are not limited to the original training data used by the pretrained models).

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is an example algorithm for a data-free model fusion framework, in accordance with example embodiments;

FIG. 2 is a block diagram of the data-free model fusion framework, in accordance with an example embodiment;

FIG. 3 is a table showing the results of example embodiments, in accordance with example embodiments; and

FIG. 4 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

In a model marketplace scenario, multiple parties can submit artificial intelligence (AI) models that accomplish similar tasks. These pretrained networks might have different architectures and be trained using different datasets. If a user wants to use these models in the marketplace for inference tasks, one of these models could be selected by the user without knowing which model would perform the best on the target data, or the user could use multiple models in an ensemble and pay the extra cost of using several models. The marketplace owner can fuse all these models into a single model that can provide the user with superior performance and lower cost of execution. However, the training parties may be unwilling to share their training data due to data privacy and confidentiality concerns. In addition, they may not agree to participate in a federated learning collaboration to repeatedly retrain their model.

Generally, a data-free model fusion framework based on knowledge distillation is disclosed. In one or more embodiments, the knowledge distillation can be used to combine pre-trained models into one model for superior performance in terms of model performance (such as classification, robustness, scalability, etc.), infrastructure usage (such as time, memory, number of graphical processing units (GPUs), etc.), and the like, without the need for the raw training data or real data.

Knowledge distillation (KD) was originally proposed for learning a compact student model from one teacher model. Instead of learning directly from labeled data, the student model can learn from the soft labels generated by the teacher model on unlabeled data. In later systems, a student model is learned from multiple teachers. These methods either learn from the ensemble of the teacher models' outputs or from the most confident teacher model's output. To improve learning efficiency and effectiveness, most of these methods also proposed various losses so that the student not only learns from the final soft label outputs but also the intermediate features from the teachers. Depending on how the teacher models are trained, these methods generally fall in two categories: all the teachers are trained on the same dataset, or teachers are trained on different datasets (multi-talent teachers). Although these methods do not require labeled datasets, they all use real data for knowledge distillation. In fact, most of these methods use the same real data that they used for training the teachers in their studies. However, in many real-world applications, even the raw training data without annotations are not accessible. For example, medical imaging data is often subject to privacy restrictions and commercial data is often subject to intellectual property restrictions. Using out-of-domain data, or even same-domain, but out-of-distribution, data as a replacement for KD usually leads to unsatisfactory results. In these applications, model fusion without the need for the original data can be extremely helpful.

In example embodiments, data-free model fusion was considered as a problem of data-free knowledge distillation that involves multiple teachers. The teachers might or might not have the same architecture. Each pretrained teacher model was trained on a different dataset; therefore, a generator should typically be trained to match each teacher. (A generator model that matches a teacher network means that the generator is specifically trained to generate data with the same distribution as those used to train the corresponding teacher (not the other teachers).) Batch normalization (BN) loss was used to train the generators so that each generator can generate samples that follow the same BN distribution as the training data for the corresponding teacher. The adversarial loss (ADV) has been used to encourage the synthesized images to cause student-teacher disagreement, which iteratively expands the distributional coverage of the image distribution during the learning process. The ADV loss is especially effective in producing statistically diverse samples for single-teacher knowledge distillation. However, expanding the ADV loss to improve the generators in the multi-teacher setting is not a trivial problem. In a multi-teacher setting, the student is influenced by more than one teacher. Therefore, the output of the student model for each sample is dissimilar to the output of either of the teacher models. Therefore, there is always dissimilarity between the student and either of the teachers whether the sample is novel or not. As a result, rewarding dissimilarity between teachers and student in a multi-teacher setting results in confusion and deterioration of the results. However, without the adversarial loss, the generator will no longer expand the distributional coverage of the generated images which, in turn, results in sub-optimal performance. One or more embodiments advantageously address this problem by introducing Teaching Assistants (TA), to extend the application of adversarial loss to multi-teacher settings. Each Teaching Assistant is a dedicated model to a pair of teacher-generator models and is trained to mimic a teacher using samples synthesized by its corresponding generator. Therefore, it can be used to calculate a meaningful adversarial loss to train a generator to produce diversified samples and mitigate mode-collapse. Compared with conventional techniques, one or more exemplary embodiments greatly improve the data-free model fusion performance.

It is worth noting that in one or more embodiments, rather than using teaching assistants to assist the student learning process by reducing the gap between the student and teacher, the teaching assistants are used to assist in training better generators.

To be specific, for each pretrained teacher model, a corresponding warm-up generator is first trained so that the warm-up generator can produce synthetic image samples that mimic the original training data for that teacher model. Three fidelity loss functions are used in the warm-up generator training stage: batch normalization (BN) loss, instance categorical entropy (ICE) loss and batch categorical entropy (BCE) loss. Next, multi-teacher knowledge distillation is performed to learn a student network from the multiple teacher networks using the warm-up generators. Note that, if the warm-up generators are only used without updating them anymore, the generator will no longer expand the distributional coverage of the generated image distribution. The student will eventually get familiar with the synthetic samples and no longer learn new knowledge from the teachers. Therefore, a competing loss is introduced with the help of teaching assistants (TAs) to iteratively update the generators while knowledge distillation is performed. The idea is to encourage the synthesized images to cause disagreement between each teacher and the corresponding teacher assistant, which iteratively expands the distributional coverage of the image distribution of the corresponding generator. The TAs are companion networks with the teacher networks and can be learned by data-free knowledge distillation from the corresponding teacher using the corresponding generator. During the multi-teacher knowledge distillation, in each iteration, each generator is first updated using the fidelity and competing losses; next, each TA is updated using data-free knowledge distillation; lastly, the target student network from the ensemble of teacher networks' knowledge is updated based on the synthesized images.

### Details

T_{θ}_{ₖ} is denoted as the k-th teacher where θₖ are the learnable parameters of the teacher and K is the number of teachers. The teacher networks were trained on a respective labeled training dataset and the pretrained network T_{θ*} will no longer be updated during model fusion, where θ* is the trained teacher parameters. A corresponding teaching assistant (TA) network A_{χk} is trained for each teacher, where χₖ are the learnable parameters of the TA. Denote by S_{ϕ} the student, where ϕ is the learnable parameters of the student. For simplicity, herein it is assumed that all the teachers and the student are trained for the same task of C-category classification. Since each teacher was pretrained on a different dataset, for data-free model fusion, a corresponding generator network G_{ψ}_{ₖ} is trained to match each teacher network so that the generator can produce synthetic samples that mimic the original training data.

### Training Generators

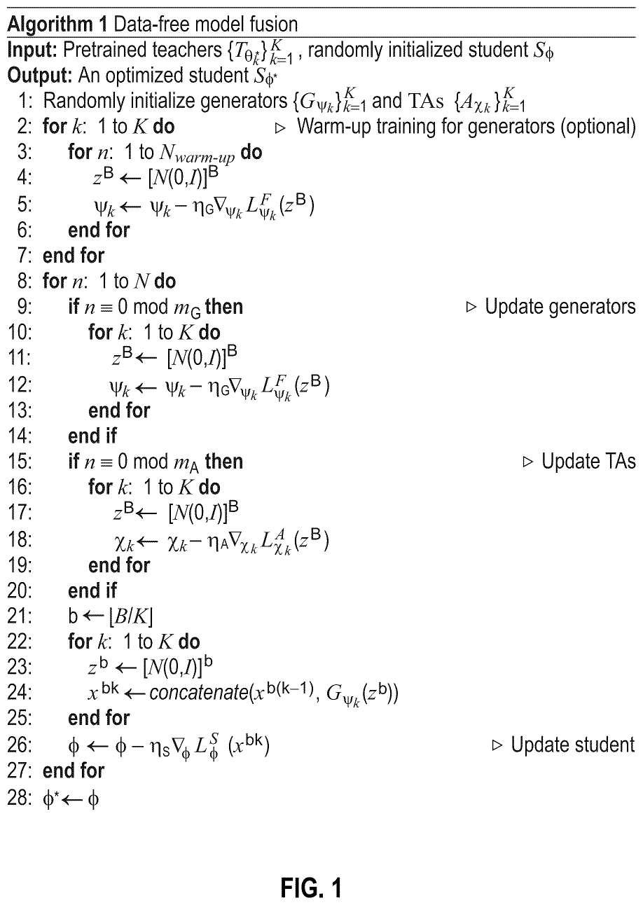

The loss function to update the generators includes two parts: fidelity loss and competing loss. (See lines 9-14 of Algorithm 1 of FIG. 1.) The fidelity loss encourages each generator to produce synthetic samples as similar to the original data as possible based on the matched teacher. The fidelity loss further includes a batch normalization (BN) loss, an instance categorical entropy (ICE) loss and a batch categorical entropy (BCE) loss and is depicted as:

$${L}_{{ψ}_{k}}^{F} = {𝔼}_{p ( z )} [ {\sum }_{l} ( ( {\hat{μ}}_{l , {ψ}_{k}} ( z ) , {\hat{σ}}_{l , {ψ}_{k}}^{2} ( z ) ) , ( {μ}_{l} , {σ}_{l}^{2} ) ) ] + {𝔼}_{p ( z )} [ H ( {T}_{{θ}_{k}^{*}} ( {G}_{{ψ}_{k}} ( z ) ) ) ] - H ( {𝔼}_{p ( z )} [ {T}_{{θ}_{k}^{*}} ( {G}_{{ψ}_{k}} ( z ) ) ] ) \qquad ( 1 )$$

On the right part of (1), the first term is the BN loss which minimizes the Kullback-Leibler (KL) divergence of two Gaussian distributions to match the mean and variance stored in the teacher's batch normalization layers and the empirical statistics obtained with the generated samples. (The meaning of empirical statistics are described below: \hat{μ}_{l,ψ,k}(z) and \hat{σ}_{l,ψ,k}²(z) are a corresponding mean and variance computed over the synthetic samples.) Here, αₗ and σₗ² are the mean and variance stored in the l-th normalization layer and are obtained from the pretrained neural network models. For example, a program hosting the pretrained neural networks provide these stored variables μₗ and σₗ² which the pretrained neural networks developed via being trained by original training data. In another example, the variables μₗ and σₗ² are obtained by performing some inference with the pretrained neural networks and analyzing aspects of network performance or internal component performance of the network. Note that \hat{μ}_{l,ψ,k}(z) and \hat{σ}_{l,ψ,k}²(z) are the corresponding mean and variance computed over the synthetic samples G_{ψ}_{ₖ}(z). Further, [symbol] ((\hat{μ},\hat{σ}²), (μ,σ²)) is the Kullback-Leibler (KL) divergence between two Gaussian distributions, which is represented as:

$$( ( \hat{μ} , {\hat{σ}}^{2} ) , ( μ , {σ}^{2} ) ) = \frac{{( \hat{μ} - μ )}^{2} + {\hat{σ}}^{2}}{2 {σ}^{2}} - log \frac{\hat{σ}}{σ} - \frac{1}{2} . \qquad ( 2 )$$

The second term minimizes the instance categorical entropy. Assuming the teacher is well trained for accurate classification, a good generator should produce samples that yield low entropy outputs (the probability for one category should be high) from the teacher. H denotes entropy, E denotes expectation, z is the random input for the generator and p(z) the probability distribution of the random input z. The third term maximizes the batch categorical entropy. Because there is no prior knowledge of the categorical probability distribution of the original training data, it is reasonable to assume the classes appearing in the dataset follow uniform distribution. This prevents the generator from producing samples of only one or a few classes, and is achieved by maximizing the entropy of the teacher's averaged outputs over any batch.

The adversarial or competing loss encourages the synthesized images to cause disagreement between each teacher and the corresponding teacher assistant, which iteratively expands the distributional coverage of the image distribution of the corresponding generator. The adversarial loss is given by:

$${L}_{{ψ}_{k}}^{A} = - {𝔼}_{p ( z )} [ D ( {T}_{{θ}_{k}^{*}} ( {G}_{{ψ}_{k}} ( z ) ) , {A}_{{χ}^{k}} ( {G}_{{ψ}_{k}} ( z ) ) ) ] \qquad ( 3 )$$

where D stands for KL divergence. Note that a softmax with temperature τ is applied to the teacher and TA's outputs in (3).

The overall loss to train a generator is given by:

$${L}_{{ψ}_{k}}^{G} = {L}_{{ψ}_{k}}^{A} + α {L}_{{ψ}_{k}}^{F} , \qquad ( 4 )$$

where α≥0 is a weighting factor.

### Training TAs

Each TA A_{χk} learns from its matched teacher T_{θ*}_{ₖ} through knowledge distillation (KD) using the synthetic samples generated by the corresponding latest generator G_{ψ}_{ₖ}. (A TA model that matches a teacher model means that the TA is specifically trained to learn knowledge from the corresponding teacher model (not the other teachers), using data generated from the matched generator.) (See lines 15-20 of Algorithm 1 of FIG. 1.) Each TA can be updated by minimizing the following loss:

$${L}_{{χ}_{k}}^{A} = {𝔼}_{{x}_{k}} [ D ( {T}_{{θ}_{k}^{*}} ( {x}_{k} ) , {A}_{{χ}^{k}} ( {x}_{k} ) ) + β {L}_{{χ}_{k} , {θ}_{k}^{*}}^{VID} ( {x}_{k} ) ] \qquad ( 5 )$$

where xₖ is an image produced by the k-th generator and A_{χk}(xₖ) is the output of the k-th TA, where a SoftMax with temperature τ is also applied to the teacher and TA's outputs, β is a weighting factor for the variational information distillation (VID) loss, and L_{χ}_{ₖ}_{,θ*}^{VID} is the VID loss.

### Training Student

The student S_{ϕ} learns from multiple teachers through KD using the synthetic samples as well. (See lines 21-26 of Algorithm 1 of FIG. 1.) The student is updated by minimizing the loss below:

$${L}_{ϕ}^{S} = {𝔼}_{x} [ D ( {\sum }_{k = 1}^{K} {w}_{k} {T}_{{θ}_{k}^{*}} ( x ) , {S}_{ϕ} ( x ) ) + β {\sum }_{k = 1}^{K} {w}_{k} {L}_{ϕ , {θ}_{k}^{*}}^{VID} ( x ) ] , \qquad ( 6 )$$

$$x ∈ {⋃}_{k = 1}^{K} {G}_{{ψ}_{k}} ( z )$$

where wₖ is the weight to control the importance of the k-th teacher in the learning process and Σₖ₌₁^{K}wₖ=1. Here, the union of all the generators' outputs is used as the input images x for KD.

### Implementation

FIG. 1 is an example algorithm for a data-free model fusion framework, in accordance with example embodiments. Note that η represents data rate. Note that z^{B} denotes the random input batch of size B to the generators, and L (z^{B}) denotes the loss averaged over the batch. Warm-up training for the generators is performed using the fidelity loss (1) only. (See lines 2-7 of Algorithm 1 of FIG. 1.) The pretraining procedure reduces generation of unreliable samples in the early phase. The student is updated more frequently than the generators to reduce the chance of falling into local minimum, which is controlled by m_{G}. By adjusting m_{A}, TAs can be updated less frequently than the student to reach a balance between computation speed performance, as TAs only help the generators and do not need to be as high quality as the student. In one example embodiment, all TAs are permitted to have the same architecture as the student, but the TAs can be assigned with the teachers' or other architectures as well. In this embodiment, uniform weights are used for wₖ in (6), where wₖ=1/K. In more complicated scenarios where there are mixed-quality teachers, fixed weights might fail to differentiate high-quality teachers from low-quality ones. In these scenarios, adaptively assigning sample-wise weighting for each teacher prediction can be used, with those teacher predictions close to one-hot labels assigned large weights.

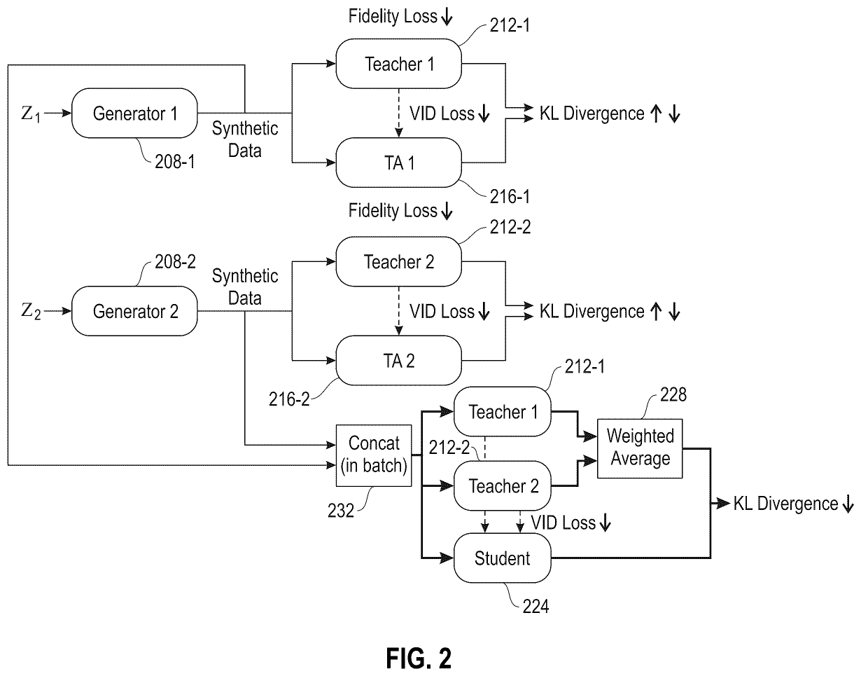

FIG. 2 is a block diagram of the data-free model fusion framework, in accordance with an example embodiment. (Arrows indicate which networks the loss functions are trying to minimize or maximize. Only 2 teachers are included in the example framework of FIG. 2, although the use of additional teachers is contemplated.)

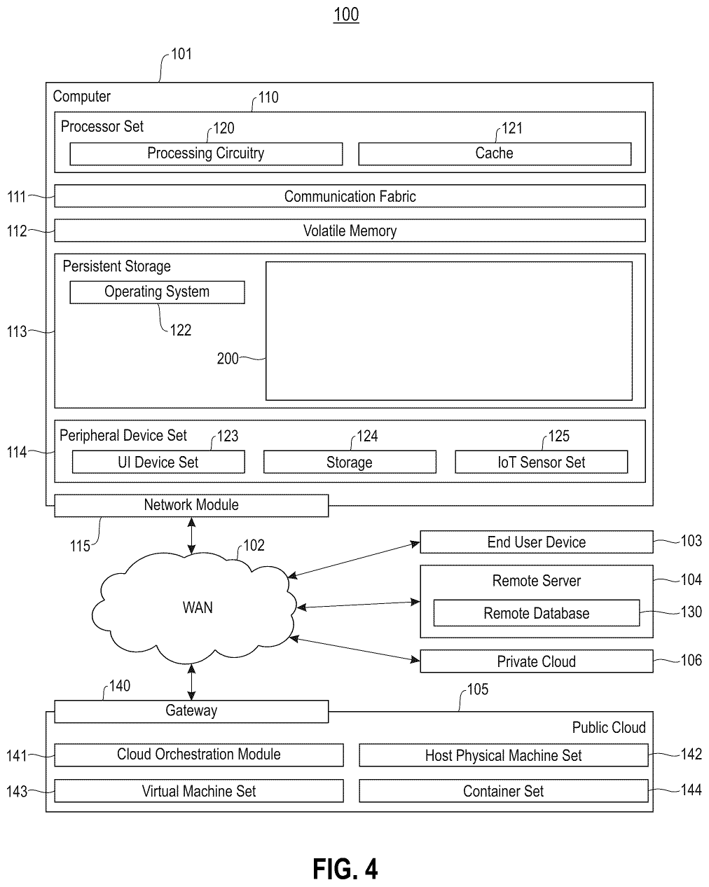

As illustrated in FIG. 2, the generators 208-1, 208-2 are trained with a loss function including two parts, a fidelity loss and a competing loss, and generate synthetic images (fake data in FIG. 2) which are provided to the teacher models 212-1, 212-2 and the teaching assistants 216-1, 216-2. As illustrated in FIG. 2, the generators 208-1, 208-2 attempt to minimize the fidelity loss and maximize the KL divergence. The teacher models 212-1, 212-2 are examples of pretrained neural network models which are accessed to perform the model fusion described herein. In some embodiments, the accessing includes receiving these pretrained neural network models. For example, the pretrained neural network models are downloaded onto the computer 101 shown in FIG. 4 and are stored in the persistent storage 113 of the computer 101. In other embodiments, the pretrained neural networks are stored remotely, e.g., in the remote server 104 or in multiple remote servers, and input samples are sent to these remote neural networks. The corresponding predictions of these remote neural networks are transmitted back to the computer 101 via a transmission over the wide area network 102.

The teaching assistants 216-1, 216-2 attempt to minimize the VID loss and the KL divergence.

The student model 224 learns from the teacher models 212-1, 212-2 through KD using the synthetic samples and is updated by minimizing the VID loss. The student model 224 also minimizes the KL divergence. As illustrated in the example of FIG. 2, the generators 208-1, 208-2, the teacher models 212-1, 212-2, and the teaching assistants 216-1, 216-2 are neural networks. The neural networks may be implemented, for example, in software on a general-purpose computer or on a high-speed computer using graphical processing units (in either case optionally with a hardware accelerator), using specialized hardware, and the like. Concatenator 232 is a concatenation function performed, for example, by software executing on a general-purpose computer. In one example embodiment, the concatenation is performed along the batch dimension (see line 26 of Algorithm 1 of FIG. 1 and the second line of equation (6)). The weighted average unit 228 is a weighted average function performed, for example, by software executing on a general-purpose computer. In one example embodiment, the weighted average is a mean calculation (see the description of FIG. 1 above). In one example, the predictions from the various teacher networks 212-1, 212-2 are weighted equally to produce the weighted average that is compared in the loss function with the prediction of the student neural network 224 on the same input sample. In other embodiments, a prediction from one of the various teacher networks 212-1, 212-2 is favored over the predictions of the other teacher networks by giving the favored network a higher weight for its prediction than the other network it receives for its predictions. A favored teacher network is in some embodiments selected by a user and/or by default from calculations within the model fusion code. In some embodiments, the weights for a particular teacher network are input by a user.

FIG. 2 shows an embodiment with one-to-one pairing of each generator with a respective teacher pretrained neural network model and additionally one-to-one pairing of one teaching assistant neural network with one respective teacher pretrained neural network model.

In other embodiments, multiple generator neural network models are trained with respect to a single respective teacher pretrained neural network model. This embodiment requires more computing power but can provide somewhat more accurately trained generators and, therefore, more accurately trained student neural network models. In other embodiments, multiple teacher assistant neural networks are trained with respect to a single respective teacher pretrained neural network model. This embodiment also requires more computing power but can provide somewhat more accurately trained generators and, therefore, more accurately trained student neural network models.

FIG. 2 shows an embodiment in which training of the student neural network occurs via combining (e.g., with concatenation function 232) synthetic samples from multiple generators and inputting the combined concatenated sample into the teachers and the student neural network (and also with performing loss optimization on a combined prediction from Teacher 1 and Teacher 2).

In other embodiments, the training of the student neural network occurs separately for some or each of the teacher pretrained neural networks and occurs sequentially. For example, the student neural network 224 is first trained in a pair with Generator 1 and the Teacher 1 (receiving synthetic samples generated by the Generator 1) and then subsequently is trained in a pair with Generator 2 and the Teacher 2 (receiving synthetic samples generated by the Generator 2).

As described above, a plurality of models are fused together such that access to the data needed to train the individual models is not needed to train the fused model. Federated learning is one example where a plurality of models are fused together. A large amount of data (such as terabytes of data) are often transferred over a network to facilitate a conventional federation learning process. In one example embodiment, the disclosed techniques are used to improve the technological process of the federated machine learning process, gathering abstractions over a network instead of transferring a large dataset over a network. Local pretrained models may be used rather than building up (over a network) a conventional framework for federated learning.

In one example embodiment, the privacy and security of personal data are facilitated for applications such as motion analysis (analyzing a walking style), handwriting analysis, and the like where student neural networks are generated (as described above) without the need for the data used to train the models that are fused together.

In one example embodiment, the fusion of models for controlling vehicles is facilitated. The makers of the models to be fused may be unwilling and/or unable to share the data used to train the unfused models. The disclosed techniques may be used to generate the fused model without access to the original training data. Moreover, the performance of the machine learning process is improved for all of the above cases by generating a fused model that generally performs better than the individual unfused models.

### Experiments and Results

Example embodiments were evaluated on a conventional image dataset (32×32 image size; 10 categories; 50K training data and 10K testing data). The conventional dataset is split into two parts to train two teachers (K=2). Two splitting modes were investigated: homogeneous (HO) mode and heterogeneous (HE) mode. In the HO mode, the whole dataset is randomly split into halves where no class distribution imbalance is present in each part. On the other hand, the HE mode simulates imbalanced class distribution where one pretrained teacher is better at some classes than the other one. To be specific, the first part consists of 75% data for the first five classes and 25% data for the last five classes, whereas the second part keeps the rest of the data.

In the experiments, the same convolutional neural network architecture was used for all the teachers, TAs and the student. In other embodiments, other architectures are used for the generators. For pretraining the teacher networks, Nesterov accelerated gradient is used with weight decay and the momentum was set as 5×10⁻⁴ and 0.9, respectively. The networks were trained for 200 epochs and the initial learning rate was set as 0.1 and divided by 10 at 80 and 120 epochs, respectively. For training the generators, the Adam optimizer with learning rate η_{G}=10⁻³ and momentum 0.5 was used. For training the TAs and the student, Nesterov accelerated gradient with cosine decaying learning rate η_{A}=η_{S}=0.05 and momentum 0.9 was used. The original VID loss was proposed to match every intermediate layer output between the teacher and student. In the experiments, for simplicity, the last convolutional layer outputs between the teacher and student (or TA) are matched. Although this sacrifices performance slightly, it scales better when the teachers and student have different architectures where layer-wise matching is difficult. The remaining of the hyperparameters that are used are: N_{warm-up}=20K, N=800K, B=256, m_{G}=10, m_{A}=2, α=0.1 and β=1.

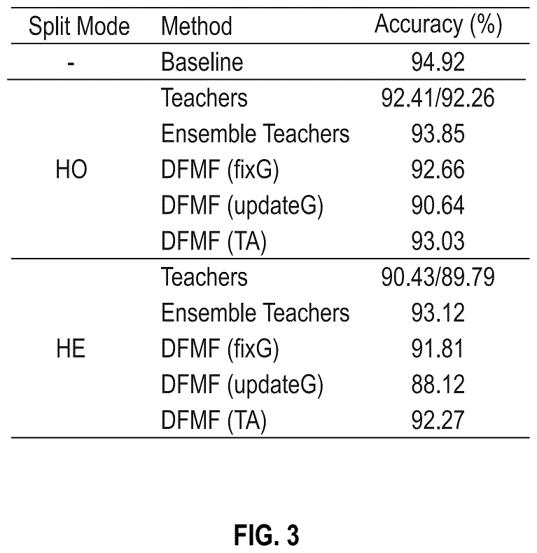

FIG. 3 is a table showing exemplary results achieved with one or more embodiments. ‘Baseline’ is the result of a convolutional neural network trained on all the training data without data split. ‘Teachers’ are the results of the two teachers trained on part of the training data. ‘Ensemble Teachers’ are the ensemble of the two teachers. ‘DFMF’ is an exemplary data-free model fusion framework with three variants. Note that ‘fixG’ means the generators are kept fixed after warm-up training. However, this will result in the generators not getting enough number of updates compared with the other groups. To enable a fair comparison, in the ‘fixG’ group, N_{warm-up}=100K was used in the warm-up training stage. Note further that ‘updateG’ means the generators are being updated without TAs, where the TA networks in (3) are replaced by the student network. ‘TA’ means the generators are being updated with the assistance of TAs. For all DFMF experiments, the models were trained three times and the average is shown as the results.

Here, although ensemble results show the highest accuracy, they are only presented as a baseline because model ensembling is expensive in terms of both time and space. Without any surprise, keeping the generators fixed after warm-up training leads to sub-optimal results, as the generator will no longer expand the distributional coverage of the generated image distribution. Without TAs, introducing disagreements between multiple teachers and one student causes con-fusion for the generators and resulted in worse results, as shown by ‘updateG.’ DFMF with TAs produced the best results compared to others.

Given the discussion thus far, it will be appreciated that, in general terms, an exemplary method, according to an aspect of the invention, includes the operations of training generator neural networks to produce synthetic samples that mimic training data used to train pretrained neural network models, respectively; training teaching assistant neural networks that learn from the pretrained neural network models through knowledge distillation using samples produced by the generator neural networks; and training a student neural network that learns from the pretrained neural network models through knowledge distillation using the synthetic samples produced by the trained generator neural networks.

In one aspect, a computer program product comprises one or more tangible computer-readable storage media and program instructions stored on at least one of the one or more tangible computer-readable storage media, the program instructions executable by a processor, the program instructions comprising training generator neural networks to produce synthetic samples that mimic training data used to train pretrained neural network models, respectively; training teaching assistant neural networks that learn from the pretrained neural network models through knowledge distillation using samples produced by the generator neural networks; and training a student neural network that learns from the pretrained neural network models through knowledge distillation using the synthetic samples produced by the trained generator neural networks.

In one aspect, a system comprises a memory and at least one processor, coupled to the memory, and operative to perform operations comprising training generator neural networks to produce synthetic samples that mimic training data used to train pretrained neural network models, respectively; training teaching assistant neural networks that learn from the pretrained neural network models through knowledge distillation using samples produced by the generator neural networks; and training a student neural network that learns from the pretrained neural network models through knowledge distillation using the synthetic samples produced by the trained generator neural networks.

In one example embodiment, the training of the generator neural networks further comprises applying one or more loss functions which cause disagreement between predictions of the teaching assistant neural networks and respective predictions of the pretrained neural network models.

In one example embodiment, the training of the student neural network comprises combining predictions of the pretrained neural network models for comparison in a loss function to a prediction of the student neural network.

In one example embodiment, the training of the student neural network comprises combining synthetic samples from different ones of the trained generator neural networks; and inputting the combined synthetic sample to the pretrained neural network models and to the student neural network.

In one example embodiment, the training of the generator neural networks comprises pairing multiple teaching assistant neural networks respectively with one of the pretrained neural network models.

In one example embodiment, the training of the generator neural networks comprises pairing multiple generator neural networks respectively with one of the pretrained neural network models.

In one example embodiment, the training the generator neural networks uses a loss function comprising a fidelity loss and an adversarial loss, wherein the loss function is applied to predictions of the pretrained neural network models and to predictions of the teacher assistant neural networks that were made in response to receiving respective samples generated by the generator neural networks.

In one example embodiment, the fidelity loss comprises at least one member selected from a group consisting of a batch normalization (BN) loss, an instance categorical entropy (ICE) loss, and a batch categorical entropy (BCE) loss.

In one aspect, an exemplary method, according to an aspect of the invention, includes the operations of accessing, using at least one hardware processor, a plurality of pretrained neural network models 212-1, 212-2; training, using the at least one hardware processor, a plurality of generator neural networks 208-1, 208-2 configured to produce synthetic samples that mimic training data used to train the pretrained neural network models 212-1, 212-2; training, using the at least one hardware processor, a plurality of teaching assistant (TA) neural networks 216-1, 216-2 that learn from the pretrained neural network models 212-1, 212-2 through knowledge distillation (KD) using the synthetic samples produced by the generator neural networks 208-1, 208-2; training, using the at least one hardware processor, a student neural network 224 that learns from the pretrained neural network models 212-1, 212-2 through knowledge distillation (KD) using the synthetic samples produced by the generator neural networks 208-1, 208-2; and facilitating deployment (e.g., actually deploying or making available for deployment by sharing the file that contains the model) of the student neural network 224 in a machine learning system.

Advantageously, carrying out the steps above results in the generator neural network 208-1, 208-2 producing more diverse and effective samples.

In one example embodiment, each of the pretrained neural network models 212-1, 212-2 (teacher networks) is trained on a different training dataset or a same training dataset. In other words, the training procedure for the generators, teaching assistants, and student models is considered agnostic with respect to training datasets used to pretrain the teacher neural network models.

In one example embodiment, each of the pretrained neural network models 212-1, 212-2 (teacher networks) has a different architecture or a same architecture. In other words, the training procedure for the generators, teaching assistants, and student models is considered agnostic with respect to architecture of the pretrained teacher neural network models.

In one example embodiment, each of the pretrained neural network models 212-1, 212-2 (teacher networks) is configured to be trained for identical tasks or different tasks. In other words, the training procedure for the generators, teaching assistants, and student models is considered agnostic with respect to tasks which the pretrained teacher neural network models were trained to perform.

In one example embodiment, the teaching assistant (TA) neural networks 216-1, 216-2 are configured to have a same architecture as the corresponding pretrained neural network models 212-1, 212-2 (teacher networks), a same architecture as the student neural network 224, or architectures different from any of the pretrained neural network models 212-1, 212-2 (teacher networks) and the student neural network 224. In other words, the training procedure for the generators, teaching assistants, and student models is considered agnostic with respect to architecture of the teaching assistant neural network models as they relate to architecture of the pretrained neural network models and to the architecture of the student neural network (while still having the teaching assistants predict contrary to the prediction of the corresponding teacher neural network model).

In one example embodiment, one or more of the teaching assistant (TA) neural networks 216-1, 216-2 is trained to match each pretrained neural network model 212-1, 212-2 (teacher network).

In one example embodiment, one or more of the generator neural networks 208-1, 208-2 is trained to match each pretrained neural network model 212-1, 212-2 (teacher network).

In one example embodiment, the training of the generator neural networks 208-1, 208-2 is based on loss functions that cause disagreement between the pretrained neural network models 212-1, 212-2 (teacher networks) and the teaching assistant (TA) neural networks 216-1, 216-2.

In one example embodiment, the training the plurality of generator neural networks 208-1, 208-2 uses a loss function comprising a fidelity loss and a competing loss, wherein the fidelity loss encourages each generator neural network 208-1, 208-2 to produce the synthetic samples as similar to the training data based on corresponding pretrained neural network models 212-1, 212-2 (teacher networks), wherein the fidelity loss is further comprised of a batch normalization (BN) loss, an instance categorical entropy (ICE) loss and a batch categorical entropy (BCE) loss.

In one example embodiment, the fidelity loss is defined as:

$${L}_{{ψ}_{k}}^{F} = {𝔼}_{p ( z )} [ {\sum }_{l} ( ( {\hat{μ}}_{l , {ψ}_{k}} ( z ) , {\hat{σ}}_{l , {ψ}_{k}}^{2} ( z ) ) , ( {μ}_{l} , {σ}_{l}^{2} ) ) ] + {𝔼}_{p ( z )} [ H ( {T}_{{θ}_{k}^{*}} ( {G}_{{ψ}_{k}} ( z ) ) ) ] - H ( {𝔼}_{p ( z )} [ {T}_{{θ}_{k}^{*}} ( {G}_{{ψ}_{k}} ( z ) ) ] )$$

wherein the batch normalization (BN) loss minimizes a Kullback-Leibler (KL) divergence of two Gaussian distributions to match a mean and a variance stored in batch normalization layers of the corresponding pretrained neural network model 212-1, 212-2 and empirical statistics obtained with the synthetic samples G_{ψ}_{ₖ}(z), wherein μₗ and σₗ² are the mean and the variance, respectively, stored in an l-th normalization layer and are learned from the training data, \hat{μ}_{l,ψ,k}(z) and \hat{σ}_{l,ψ,k}²(z) are a corresponding mean and variance, respectively, computed over the synthetic samples G_{ψ}_{ₖ}(z), H denotes entropy, [symbol] denotes expectation, z is a random input for a corresponding generator neural network 208-1, 208-2, p (z) is a probability distribution of the random input z, T_{θ}_{ₖ} denotes a k-th teaching assistant (TA) neural network 216-1, 216-2 where Ok are learnable parameters of a corresponding teaching assistant (TA) neural network 216-1, 216-2, K is a count of pretrained neural network models 212-1, 212-2 (teacher networks), and [symbol] ((\hat{μ},\hat{σ}²), (μ,σ²)) is a Kullback-Leibler (KL) divergence between two Gaussian distributions, which is represented as:

$$( ( \hat{μ} , {\hat{σ}}^{2} ) , ( μ , {σ}^{2} ) ) = \frac{{( \hat{μ} - μ )}^{2} + {\hat{σ}}^{2}}{2 {σ}^{2}} - log \frac{\hat{σ}}{σ} - \frac{1}{2} .$$

In one example embodiment, a competing loss of the training of the plurality of generator neural networks 208-1, 208-2 is given by:

$${L}_{{ψ}_{k}}^{C} = - {𝔼}_{p ( z )} [ D ( {T}_{{θ}_{k}^{*}} ( {G}_{{ψ}_{k}} ( z ) ) , {A}_{{χ}^{k}} ( {G}_{{ψ}_{k}} ( z ) ) ) ]$$

wherein D stands for a KL divergence and A_{χk} denotes a corresponding teaching assistant (TA) network 216-1, 216-2.

In one example embodiment, an overall loss of the training the plurality of generator neural networks 208-1, 208-2 is given by:

$${L}_{{ψ}_{k}}^{G} = {L}_{{ψ}_{k}}^{C} + α {L}_{{ψ}_{k}}^{F} ,$$

wherein α≥0 is a weighting factor.

In one example embodiment, the training of the plurality of teaching assistant (TA) neural networks 216-1, 216-2 uses a variational information distillation (VID) to match intermediate layer outputs between a given teaching assistant (TA) neural network 216-1, 216-2 and the corresponding pretrained neural network model 212-1, 212-2 (teacher network) and the given teaching assistant (TA) neural network 216-1, 216-2 is updated by minimizing a loss defined by:

$${L}_{{χ}_{k}}^{A} = {𝔼}_{{x}_{k}} [ D ( {T}_{{θ}_{k}^{*}} ( {x}_{k} ) , {A}_{{χ}^{k}} ( {x}_{k} ) ) + β {L}_{{χ}_{k} , {θ}_{k}^{*}}^{VID} ( {x}_{k} ) ]$$

wherein xₖ is an image produced by a k-th generator neural network 208-1, 208-2, T_{θ}_{ₖ} denotes a k-th teaching assistant (TA) neural network 216-1, 216-2, and A_{χk}(xₖ) is an output of the k-th teaching assistant (TA) neural network 216-1, 216-2, where a SoftMax with temperature τ is applied to the pretrained neural network models 212-1, 212-2 (teacher networks) and outputs of the teaching assistant (TA) neural network 216-1, 216-2, L_{χk,θ*}^{VID} is a VID loss, and β is a weighting factor for the VID loss.

In one example embodiment, the student neural network S_{ϕ} is updated by minimizing a loss defined as:

$${L}_{ϕ}^{S} = {𝔼}_{x} [ D ( {\sum }_{k = 1}^{K} {w}_{k} {T}_{{θ}_{k}^{*}} ( x ) , {S}_{ϕ} ( x ) ) + β {\sum }_{k = 1}^{K} {w}_{k} {L}_{ϕ , {θ}_{k}^{*}}^{VID} ( x ) ] ,$$

$$x ∈ {⋃}_{k = 1}^{K} {G}_{{ψ}_{k}} ( z )$$

where [symbol] denotes expectation, D stands for a KL divergence, T_{θ}_{ₖ} denotes a k-th teaching assistant (TA) neural network 216-1, 216-2 where θₖ are learnable parameters of a corresponding teaching assistant (TA) neural network 216-1, 216-2, G_{ψ}_{ₖ}(z) denotes the synthetic samples, L_{χk,θ*}^{VID} is a VID loss, β is a weighting factor for the VID loss, L_{χk,θ*}^{VID} is the VID loss, wₖ is a weight to control an importance of the k-th pretrained neural network model 212-1, 212-2 in a learning process and Σₖ₌₁^{K}wₖ=1.

In one example embodiment, inferencing is performed using the deployed student neural network 224. For example, new data samples are input into the deployed student neural network 224 and, in response, the deployed student neural network produces predictions, e.g., class membership predictions, for some or all of those new data samples. The predictions are presented via the computer 101 e.g., via displaying the predictions on a display screen of the computer 101 and/or are audibly played via an audio speaker that is connected to the computer 101. As a precursor to the inferencing, the trained student neural network is deployed. For example, a copy of the trained student neural network is downloaded to another computer at which new samples will be input to the trained student neural network. In other embodiments, the trained student neural network is accessed by another computer located remotely from the trained student neural network. New samples are transmitted across a wide area network to the trained student neural network to perform the inferencing. Inferencing results, e.g., class predictions, made by the student neural network in response to the inputting of the new samples are transmitted back across the wide area network to the accessing computer.

In one aspect, a computer program product comprises one or more tangible computer-readable storage media and program instructions stored on at least one of the one or more tangible computer-readable storage media, the program instructions executable by a processor, the program instructions comprising accessing a plurality of pretrained neural network models 212-1, 212-2; training a plurality of generator neural networks 208-1, 208-2 configured to produce synthetic samples that mimic training data used to train the pretrained neural network models 212-1, 212-2; training a plurality of teaching assistant (TA) neural networks 216-1, 216-2 that learn from the pretrained neural network models 212-1, 212-2 through knowledge distillation (KD) using the synthetic samples produced by the generator neural networks 208-1, 208-2; training a student neural network 224 that learns from the pretrained neural network models 212-1, 212-2 through knowledge distillation (KD) using the synthetic samples produced by the generator neural networks 208-1, 208-2; and facilitating deployment of the student neural network 224 in a machine learning system.

In one aspect, a system comprises a memory and at least one processor, coupled to the memory, and operative to perform operations comprising accessing a plurality of pretrained neural network models 212-1, 212-2; training a plurality of generator neural networks 208-1, 208-2 configured to produce synthetic samples that mimic training data used to train the pretrained neural network models 212-1, 212-2; training a plurality of teaching assistant (TA) neural networks 216-1, 216-2 that learn from the pretrained neural network models 212-1, 212-2 through knowledge distillation (KD) using the synthetic samples produced by the generator neural networks 208-1, 208-2; training a student neural network 224 that learns from the pretrained neural network models 212-1, 212-2 through knowledge distillation (KD) using the synthetic samples produced by the generator neural networks 208-1, 208-2; and facilitating deployment of the student neural network 224 in a machine learning system.

Refer now to FIG. 4.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as system 200 which can implement, for example, a data-free fusion model as described herein; a machine learning system (e.g., using a student neural network as described herein); and the like. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
training generator neural networks to produce synthetic samples that mimic training data used to train pretrained neural network models, respectively;
training teaching assistant neural networks that learn from the pretrained neural network models through knowledge distillation using samples produced by the generator neural networks; and
training a student neural network that learns from the pretrained neural network models through knowledge distillation using the synthetic samples produced by the trained generator neural networks.

2. The computer-implemented method of claim 1, wherein the training of the generator neural networks further comprises applying one or more loss functions which cause disagreement between predictions of the teaching assistant neural networks and respective predictions of the pretrained neural network models.

3. The computer-implemented method of claim 1, wherein the training of the student neural network comprises combining predictions of the pretrained neural network models for comparison in a loss function to a prediction of the student neural network.

4. The computer-implemented method of claim 1, wherein the training of the student neural network comprises:
combining synthetic samples from different ones of the trained generator neural networks; and
inputting the combined synthetic sample to the pretrained neural network models and to the student neural network.

5. The computer-implemented method of claim 1, wherein the training of the generator neural networks comprises pairing multiple teaching assistant neural networks respectively with one of the pretrained neural network models.

6. The computer-implemented method of claim 1, wherein the training of the generator neural networks comprises pairing multiple generator neural networks respectively with one of the pretrained neural network models.

7. The computer-implemented method of claim 1, wherein the training the generator neural networks uses a loss function comprising a fidelity loss and an adversarial loss, wherein the loss function is applied to predictions of the pretrained neural network models and to predictions of the teacher assistant neural networks that were made in response to receiving respective samples generated by the generator neural networks.

8. The computer-implemented method of claim 7, wherein the fidelity loss comprises at least one member selected from a group consisting of a batch normalization (BN) loss, an instance categorical entropy (ICE) loss, and a batch categorical entropy (BCE) loss.

9. The computer-implemented method of claim 7, wherein the fidelity loss is defined as:
$${L}_{{ψ}_{k}}^{F} = {𝔼}_{p ( z )} [ {\sum }_{l} ( ( {\hat{μ}}_{l , {ψ}_{k}} ( z ) , {\hat{σ}}_{l , {ψ}_{k}}^{2} ( z ) ) , ( {μ}_{l} , {σ}_{l}^{2} ) ) ] + {𝔼}_{p ( z )} [ H ( {T}_{{θ}_{k}^{*}} ( {G}_{{ψ}_{k}} ( z ) ) ) ] - H ( {𝔼}_{p ( z )} [ {T}_{{θ}_{k}^{*}} ( {G}_{{ψ}_{k}} ( z ) ) ] )$$
wherein a batch normalization (BN) loss minimizes a Kullback-Leibler (KL) divergence of two Gaussian distributions to match a mean and a variance stored in batch normalization layers of the corresponding pretrained neural network model and empirical statistics obtained with the synthetic samples G_{ψ}_{ₖ}(z), wherein μₗ and σₗ² are the mean and a variance, respectively, stored in an l-th normalization layer and are learned from the training data, \hat{μ}_{l,ψ,k}(z) and \hat{σ}_{l,ψ,k}²(z) are a corresponding mean and variance, respectively, computed over the synthetic samples G_{ψ}_{ₖ}(z), H denotes entropy, [symbol] denotes expectation, z is a random input for a corresponding generator neural network, p(z) is a probability distribution of the random input z, T_{θ}_{ₖ} denotes a k-th teaching assistant (TA) neural network where Ok are learnable parameters of a corresponding teaching assistant (TA) neural network, K is a count of pretrained neural network models 212-1, 212-2, and [symbol] ((\hat{μ},\hat{σ}²), (μ,σ²)) is a Kullback-Leibler (KL) divergence between two Gaussian distributions, which is represented as:
$$( ( \hat{μ} , {\hat{σ}}^{2} ) , ( μ , {σ}^{2} ) ) + \frac{{( \hat{μ} - μ )}^{2} + {\hat{σ}}^{2}}{2 {σ}^{2}} - log \frac{\hat{σ}}{σ} - \frac{1}{2} .$$

10. The computer-implemented method of claim 9, wherein the adversarial loss of the training of the plurality of generator neural networks is given by:
$${L}_{{ψ}_{k}}^{A} = - {𝔼}_{p ( z )} [ D ( {T}_{{θ}_{k}^{*}} ( {G}_{{ψ}_{k}} ( z ) ) , {A}_{{χ}^{k}} ( {G}_{{ψ}_{k}} ( z ) ) ) ]$$
wherein D stands for the Kullback-Leibler (KL divergence) and A_{χk} denotes a corresponding teaching assistant (TA) network.

11. The computer-implemented method of claim 10, wherein an overall loss of the training the plurality of generator neural networks is given by:
$${L}_{{ψ}_{k}}^{G} = {L}_{{ψ}_{k}}^{A} + α {L}_{{ψ}_{k}}^{F} ,$$
wherein α≥0 is a weighting factor.

12. The computer-implemented method of claim 10, wherein the training of the plurality of teaching assistant (TA) neural networks uses a variational information distillation (VID) to match intermediate layer outputs between a given teaching assistant (TA) neural network and the corresponding pretrained neural network model and further comprising updating the given teaching assistant (TA) neural network by minimizing a loss defined by:
$${L}_{{χ}_{k}}^{A} = {𝔼}_{{x}_{k}} [ D ( {T}_{{θ}_{k}^{*}} ( {x}_{k} ) , {A}_{{χ}^{k}} ( {x}_{k} ) ) + β {L}_{{χ}_{k} , {θ}_{k}^{*}}^{VID} ( {x}_{k} ) ]$$
wherein xₖ is an image produced by a k-th generator neural network, T_{θ}_{ₖ} denotes a k-th teaching assistant (TA) neural network, and A_{ψk}(xₖ) is an output of the k-th teaching assistant (TA) neural network, where a SoftMax with temperature τ is applied to the pretrained neural network models and outputs of the teaching assistant (TA) neural network, L_{χk,θ*}^{VID} is a variational information distillation (VID) loss, and β is a weighting factor for the variational information distillation (VID) loss.

13. The computer-implemented method of claim 1, further comprising updating the student neural network by minimizing a loss defined as:
$${L}_{ϕ}^{S} = {𝔼}_{x} [ D ( {\sum }_{k = 1}^{K} {w}_{k} {T}_{{θ}_{k}^{*}} ( x ) , {S}_{ϕ} ( x ) ) + β {\sum }_{k = 1}^{K} {w}_{k} {L}_{ϕ , {θ}_{k}^{*}}^{VID} ( x ) ] ,$$
$$x ∈ {⋃}_{k = 1}^{K} {G}_{{ψ}_{k}} ( z )$$
where [symbol] denotes expectation, D stands for a KL divergence, T_{θ}_{ₖ} denotes a k-th teaching assistant (TA) neural network where θₖ are learnable parameters of a corresponding teaching assistant (TA) neural network, G_{ψk}(z) denotes the synthetic samples, L_{χk,θ*}^{VID} is a variational information distillation (VID) loss, β is a weighting factor for the variational information distillation (VID) loss, wₖ is a weight to control an importance of the k-th pretrained neural network model in a learning process and Σₖ₌₁^{K}wₖ=1.

14. The computer-implemented method of claim 1, further comprising performing inferencing using the student neural network.

15. A computer program product, comprising:
one or more tangible computer-readable storage media and program instructions stored on at least one of the one or more tangible computer-readable storage media, the program instructions executable by a processor, the program instructions comprising:
training generator neural networks to produce synthetic samples that mimic training data used to train pretrained neural network models, respectively;
training teaching assistant neural networks that learn from the pretrained neural network models through knowledge distillation using samples produced by the generator neural networks; and
training a student neural network that learns from the pretrained neural network models through knowledge distillation using the synthetic samples produced by the trained generator neural networks.

16. A system comprising:
a memory; and
at least one processor, coupled to said memory, and operative to perform operations comprising:
training generator neural networks to produce synthetic samples that mimic training data used to train pretrained neural network models, respectively;
training teaching assistant neural networks that learn from the pretrained neural network models through knowledge distillation using samples produced by the generator neural networks; and
training a student neural network that learns from the pretrained neural network models through knowledge distillation using the synthetic samples produced by the trained generator neural networks.

17. The system of claim 16, wherein the training of the generator neural networks further comprises applying one or more loss functions which cause disagreement between predictions of the teaching assistant neural networks and respective predictions of the pretrained neural network models.

18. The system of claim 16, wherein the training of the student neural network comprises combining predictions of the pretrained neural network models for comparison in a loss function to a prediction of the student neural network.

19. The system of claim 16, wherein the training of the student neural network comprises:
combining synthetic samples from different ones of the trained generator neural networks; and
inputting the combined synthetic sample to the pretrained neural network models and to the student neural network.

20. The system of claim 16, wherein the training the generator neural networks uses a loss function comprising a fidelity loss and an adversarial loss, wherein the loss function is applied to predictions of the pretrained neural network models and to predictions of the teacher assistant neural networks that were made in response to receiving respective samples generated by the generator neural networks.
